(19) United States
(12) Patent Application Publication
(10) Pub. No.: US 2010/0205437 A1
(43) Pub. Date: Aug. 12, 2010

(54) Protection method and device for a mobile IPV6 fast handover

(75) Inventor: Chunqiang Li, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/767,595

(22) Filed: Apr. 26, 2010

Related U.S. Application Data
(63) Continuation of application No. PCT/CN2008/072989, filed on Nov. 7, 2008.

(30) Foreign Application Priority Data
Nov. 9, 2007 (CN) 200710188106.9

(51) Int. Cl. H04L 9/32

(52) U.S. Cl. 713/168; 380/272; 380/44

(57) ABSTRACT

A protection method for a mobile IPv6 fast handover is provided, which includes the following steps: generating a fast-handover signaling protection key by using a key which is shared with a network side device; generating an authentication code according to the protection key; adding the authentication code to the fast-handover signaling and transmitting the fast-handover signaling to a router. A protection device for a mobile IPv6 fast handover is also provided. By using the method, the shared key between the mobile node and the network side device is used to derive the fast-handover signaling protection key to protect the fast-handover signaling, which solves the security problem of the fast-handover message during a mobile IPv6 fast handover, decreases overhead during storing and calculating regarding the mobile node, and can be used to protect the downward fast-handover signaling of the SeND protocol that cannot be supported by the mobile node.

### CROSS-REFERENCE TO RELATED APPLICATIONS

This application is a continuation of International Application No. PCT/CN2008/072989, filed on Nov. 7, 2008, which claims priority to Chinese Patent Application No. 200710188106.9, filed on Nov. 9, 2007, both of which are hereby incorporated by reference in their entireties.

### FIELD OF THE INVENTION

The present disclosure relates to the technical field of communications, and more particularly to a protection method and device for a mobile IPv6 fast handover.

### BACKGROUND OF THE INVENTION

A mobile Internet Protocol version 6 (IPv6) makes a mobile node (MN) keep its connectivity when moving to another access router (AR) from one AR, the process of which is called as handover with reference to FIG. 1.

During handover, due to the link switching delay and IPv6 protocol operation, the MN cannot transmit or receive data packet within a certain time. Such a handover delay caused by a standard mobile IPv6 program (that is, mobile detection, new care of address configuration, binding update, and so on) is not acceptable for real-time flow, for example, voice over IP (VoIP). In addition, for the application which is not real time but pays close attention to throughout, the reduction of handover delay may also bring great benefits.

To reduce a handover delay, a Fast Handover for Mobile IPv6 (FMIPv6) extends the mobile IPv6. The mobile IPv6 fast handover makes the mobile node be capable of fast detecting whether the mobile node has moved to a new subnetwork. This is accomplished by providing, when the mobile node is still connected to the current subnetwork, information on a new access point and a relevant subnetwork prefix. The mobile IPv6 fast handover establishes a tunnel between a Previous Care of Address (PCoA) and a new Care of Address (nCoA), and the MN transmits a Fast Binding Update (FBU) message to a Previous Access Router (pAR). After receiving the FBU and acknowledging the validity of the nCoA of the MN by interacting with a New Access Router (nAR), the pAR transmits a Fast Binding Acknowledgement (FBAck) message to the MN, and establishes binding between the PCoA and nCoA on the pAR so that the flow transmitted to pAR link PCoA is redirected to the nCoA of a new access link.

The method has a problem. That is, if there is no mechanism for authenticating the FBU message, an attacker can transmit a forged FBU message to steal the flow of the MN or redirect the flow to a different address. To address this problem, the conventional art provides a method for protecting FBU by distributing a shared key between the pAR and the MN through a Secure Neighbor Discovery (SeND) protocol and by using this shared key. The specific principle is as follows.

The SeND is used to protect a proxy router request and a proxy router advertisement message, and during interaction of the two messages, the MN and the AR transmit an encrypted and shared handover key. The MN generates a pair of public key and private key configured to encrypt and decrypt the exchange of the shared handover key, the public key being identical with the shared key used by SeND. The MN transmits a Router Solicitation for Proxy Advertisement (RtSolPr) message which carries a handover key request option including the public key configured to encrypt the handover key. A source address of the RtSolPt message is a Care of Address (CoA) generated by the MN based on Cryptographically Generated Address (CGA), and the message needs to be signed with MN CGA key, including a CGA parameter option. The AR authenticates the message by using SeND, the public key is used to encrypt a shared handover key after the message passes authentication, and the encrypted handover key is placed in the handover key reply option of a Proxy Router Advertisement (PrRtAdv) message and is transmitted to the MN, and the MN may obtain the shared handover key through decryption. When MN transmits FBU to AR, its authorized MAC can be generated by using the handover key.

The conventional art has at least the following problems:

The solution needs to support the SeND, because in this case CoA is generated based on the CGA mode, the solution is not adapted to CoA generated by other ways. In addition, CGA is based on public key cryptography and is complex in calculation. Therefore, the mechanism makes overhead of resources larger for the mobile terminal with low computation ability and relatively valuable storage resources. In addition, in the SeND protocol, the MN also needs to authenticate the message transmitted by an AR, and thus the AR needs to sign the message transmitted by the AR by using the public key cryptography mechanism of the AR. This requires larger computation overhead and the support of a public key certificate mechanism.

### SUMMARY OF THE INVENTION

An embodiment of the present disclosure provides a protection method and device for a mobile IPv6 fast handover, protecting a fast-handover signaling of interaction between a mobile node and network side device in the scenario of a mobile IPv6 fast handover.

An embodiment of the present disclosure provides a protection method for a mobile IPv6 fast handover. The method includes the following steps: generating a fast-handover signaling protection key by using a key which is shared with a network side device; generating an authentication code according to the protection key; and adding the authentication code to a fast-handover signaling and transmitting the fast-handover signaling to a router.

An embodiment of the present disclosure further provides a protection method for a mobile IPv6 fast handover. The method includes the following steps: receiving the fast-handover signaling which carries an authentication code and is transmitted by a mobile node; acquiring a protection key which is used by the mobile node to generate the authentication code, where the protection key is generated by the mobile node using a key which is shared with a network side device; and authenticating the authentication code of the fast-handover signaling according to the protection key, and transmitting a response to the mobile node when the authentication code passes authentication.

An embodiment of the present disclosure further provides a mobile node. The mobile node includes: a protection key generating unit, configured to generate a fast-handover signaling protection key by using a key which is shared with a network side device; an authentication code generating unit, configured to generate an authentication code according to the protection key generated by the protection key generating unit; and an authentication code adding unit, configured to add the authentication code generated by the authentication code generating unit to a fast-handover signaling and transmit the fast-handover signaling to a router.

An embodiment of the present disclosure further provides a routing device. The routing device includes: an authentication code acquiring unit, configured to acquire an authentication code carried in a fast-handover signaling from a mobile node; a protection key acquiring unit, configured to acquire, from a local device or a network side device, a protection key which is used by the mobile node to generate the authentication code, where the protection key is generated by the mobile node using a key shared with a network side device; and an authenticating unit, configured to authenticate, according to the protection key acquired by the protection key acquiring unit, the authentication code acquired by the authentication code acquiring unit, and configured to transmit a response to the mobile node when the authentication code passes authentication.

An embodiment of the present disclosure further provides a protection system for a fast IPv6 fast handover, including the preceding mobile node and the preceding routing device.

Compared with the conventional art, the embodiment of the present disclosure has the following advantages: by using the shared key between the mobile node and the network side device, a fast-handover signaling protection key is derived to protect the fast-handover signaling. Such arrangement solves the security problem of the fast-handover message during a mobile IPv6 fast handover, decrease overhead during storing and calculating regarding the mobile node, and can be used to protect the downward fast-handover signaling of the SeND protocol that cannot be supported by the mobile node.

### BRIEF DESCRIPTION OF THE DRAWINGS

FIG. 1 is a schematic diagram illustrating a handover scenario of the mobile node in the conventional art;

FIG. 2 is a schematic diagram illustrating a fast-handover flow of the mobile node in the conventional art;

FIG. 3 is a flowchart illustrating a protection method for a mobile IPv6 fast handover according to the first embodiment of the present disclosure;

FIG. 4 is a flowchart illustrating a protection method for a mobile IPv6 fast handover according to the second embodiment of the present disclosure;

FIG. 5 is a flowchart illustrating a protection method for a mobile IPv6 fast handover according to the third embodiment of the present disclosure;

FIG. 6 is a flowchart illustrating a protection method for a mobile IPv6 fast handover according to the fourth embodiment of the present disclosure; and

FIG. 7 is a schematic diagram illustrating a protection system for a mobile IPv6 fast handover according to the fifth embodiment of the present disclosure.

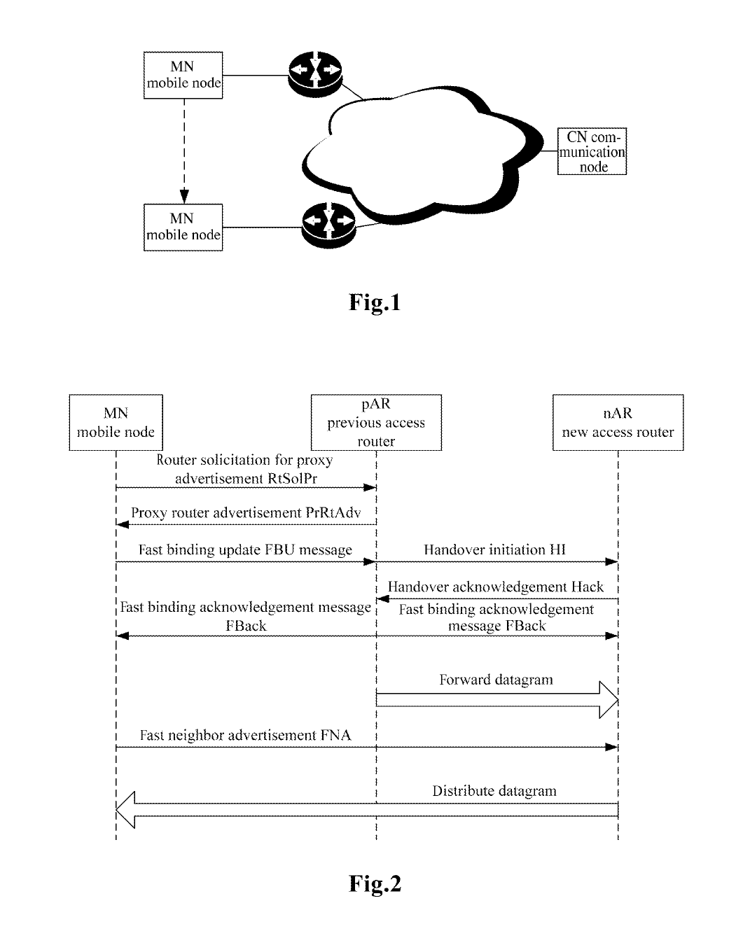

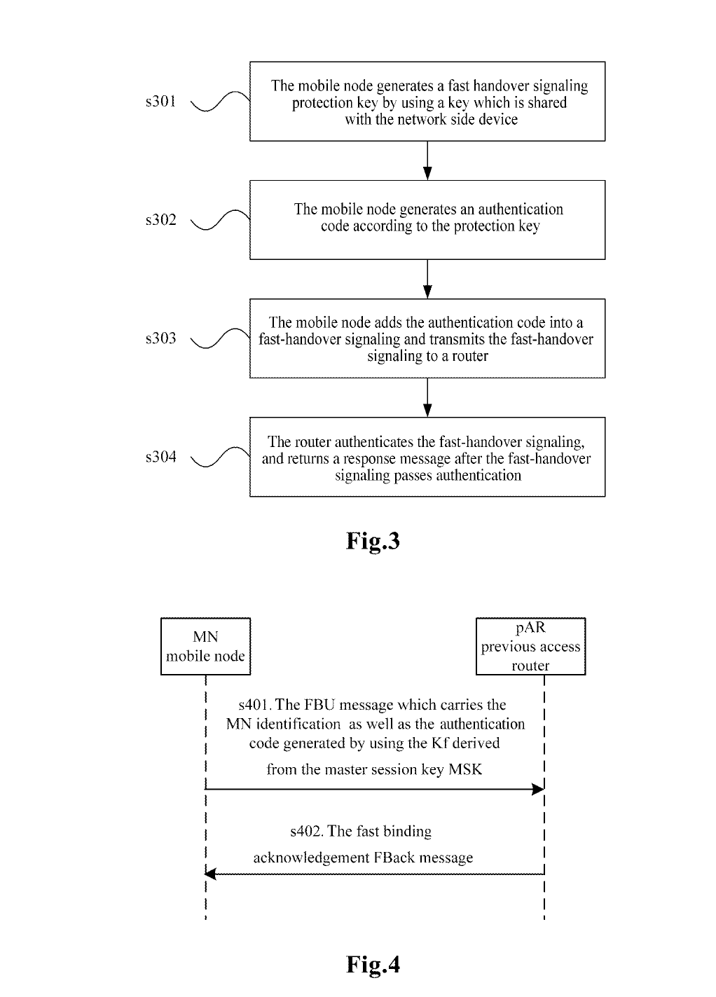

### DETAILED DESCRIPTION OF THE INVENTION

The embodiment of the present disclosure is further described below with reference to drawings and exemplary embodiments.

The first embodiment of the present disclosure provides a protection method for a mobile IPv6 fast handover, which is described below with reference to FIG. 3. The protection method includes the following steps.

In step s301, the mobile node generates a fast-handover signaling protection key by using a key which is shared with the network side device.

Specifically, the shared key can be a Master Session Key (MSK) which is generated during an access authentication of the mobile node and is shared between the network side device and the mobile node. The key which has been shared between other mobile nodes and the network side device also can be used.

In step s302, the mobile node generates an authentication code according to the protection key.

Specifically, the step of generating the protection key may also involve other parameters including one or a plurality of the following parameters: a mobile node device identification, a previous router identification, a rear router identification, a preset character string, a previous care of address, a new care of address, a length of the protection key, and a random number.

In step s303, the mobile node adds the authentication code to a fast-handover signaling and transmits the fast-handover signaling to a router.

Specifically, the fast-handover signaling can be the Router Solicitation for Proxy Advertisement (RtSolPr) message or the fast binding update (FBU) message.

In step s304, the router authenticates the authentication code in the fast-handover signaling, and returns a response message after the authentication code passes authentication.

Specifically, the router first needs to acquire the protection key, and use the protection key to authenticate the authentication code. The acquisition of the protection key can be realized by a protection key authentication function entity on the router or a protection key authentication function entity in the network. The response message can be the proxy router advertisement (PrRtAdv) message or the fast binding update acknowledgement (FBack) message.

By using the method provided in the embodiment of the present disclosure, the shared key between the mobile node and the network side device is used to derive the fast-handover signaling protection key to protect the fast-handover signaling. This solves the security problem of the fast-handover message during a mobile IPv6 fast handover, makes overhead become less during storing and calculating regarding the mobile node, and can be used to protect the downward fast-handover signaling of the SeND protocol that cannot be supported by the mobile node.

The embodiment of the protection method for a mobile IPv6 fast handover according to the first embodiment of the present disclosure is further described below with reference to the specific application scenario.

In the conventional art, when the MN is handed over to an nAR in the moving process, to acquire the information of a new access link (for example, subnetwork prefix), the mobile node transmits the RtSolPr message to the current access router pAR; upon the receipt of the message, the current access router pAR transmits to the mobile node the PrRtAdv message in which the information of the new access link is notified. In this way, the mobile node can be aware of the new subnetwork prefix and acquire the new care of address (nCoA) when still located on the previous access router link, which can eliminate the delay caused by the new prefix discovery after handover.

In the second embodiment of the present disclosure, taking the current access router with the function of authenticating the access authentication of the mobile node as an example, wherein the Authenticator, which is the authentication function entity on the previous access router, authenticates the access authentication of the mobile node. At this time, a protection method for a mobile IPv6 fast handover according to this embodiment is described below with reference to FIG. 4. The protection method includes the following steps.

In step s401, the MN transmits the FBU message to the pAR. The FBU message carries the MN identification and the authentication code generated by using the fast-handover key Kf which is derived from the MSK.

Specifically, after the network side device performs the access authentication, the MN obtains the MSK shared with the network side device, and the MSK is used to derive the key Kf. The method for deriving Kf can be embodied as follows.

Kf=KDF(MSK,Label|pAR_ID|MN_ID|nAR-ID|nCoA|pCoA|Key_length),

where the Key Derivation Function (KDF) is an algorithm of key derivation function, and the Label is a character string, here it can be set that Label=“FMIPv6”. The pAR_ID is a previous router identification, the nAR-ID is a new router identification, the nCoA is a new care of address identification, the pCoA is a previous care of address identification, and the Key_length is a length of the key.

The MN can further generate the authentication code according to the KF, and add the authentication code and the MN identification to the FBU message. In addition, when the network side device does not acquire the algorithm with which the Kf is derived from the MSK, the FBU message further needs to carry the KDF algorithm used in deriving the Kf. In addition, to avoid the replay attack, the FBU message can further carry a time stamp option.

Finally, the MN transmits the FBU message to the pAR.

In step s402, the pAR authenticates the authentication code in the FBU message, and transmits the FBack message to the MN after the authentication code passes authentication.

Specifically, the pAR receives the FBU message from the MN, and the mobile IPv6 fast-handover function entity in the pAR transmits a key request to the authentication function entity Authenticator. The authentication function entity Authenticator determines the MSK shared with the MN according to the MN identification, generates the Kf by using the same method as the MN according to the KDF algorithm carried in the FBU message, and distributes the key Kf to the mobile IPv6 fast-handover function entity. The mobile IPv6 fast-handover function entity authenticates the authentication code in the FBU message by using the Kf. When the authentication code passes authentication, the pAR generates the FBack message and transmits the FBack message to the MN.

By using the method provided in the embodiment of the present disclosure, the shared key MSK between the mobile node MN and the network side device is used to derive the fast-handover signaling protection key Kf to protect the fast-handover signaling, which solves the security problem of the fast-handover message during a mobile IPv6 fast handover, makes overhead become less during storing and calculating regarding the mobile node MN, and can be used to protect the downward fast-handover signaling of the SeND protocol that cannot be supported by the mobile node MN.

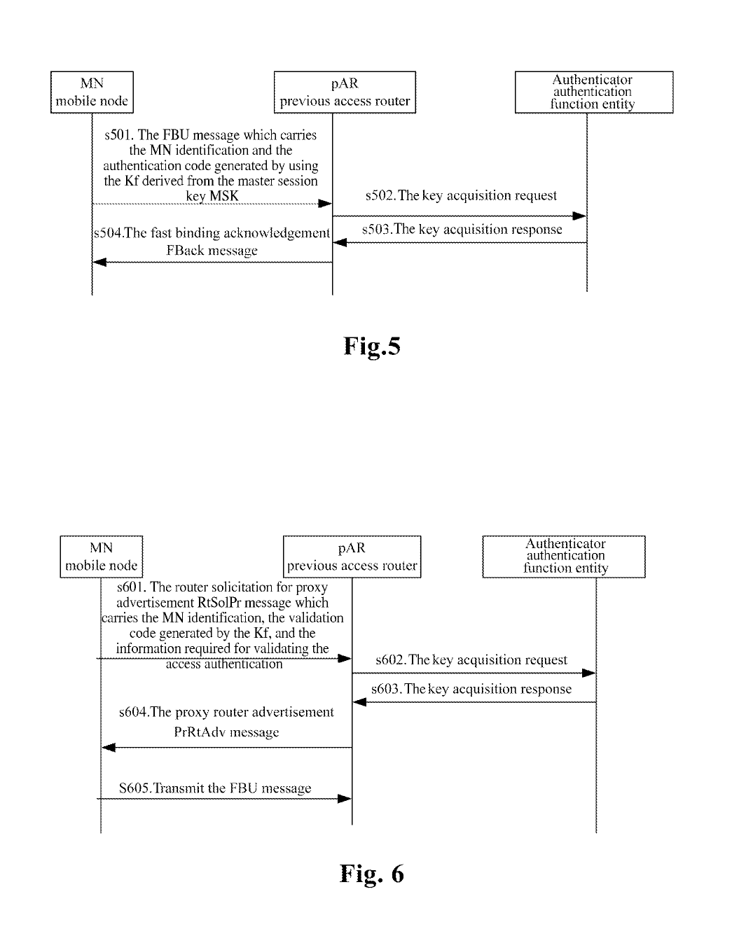

In the third embodiment of the present disclosure, taking the current access router without the function of authenticating the access authentication of the mobile node as an example, the authentication function entity Authenticator outside the previous access router authenticates the access authentication of the mobile node. In this case, a protection method for a mobile IPv6 fast handover according to the embodiment is described below with reference to FIG. 5. The protection method includes the following steps.

In step s501, the MN transmits the FBU message to the pAR. The FBU message carries the MN identification, the authentication code generated by using the Kf which is derived from the master session key MSK, and the information required for authenticating the access authentication.

Specifically, after the network side device performs the access authentication, the MN obtains the MSK shared with the network side device, and the MSK is used to derive the key Kf. The method for deriving the Kf can refer to the above step s401.

The MN generates the authentication code of the FBU message by using the Kf, and adds the authentication code and the MN identification to the FBU message. In addition, the FBU message further needs to carry the algorithm for deriving Kf, and the information required for authenticating the access authentication (such as the pAR-ID and the Authenticator-ID).

Finally, the MN transmits the FBU message to the pAR.

In step s502, the pAR transmits a key acquisition request to the authentication function entity Authenticator.

When receiving the FBU message from the MN, the pAR extracts the content included in the message and transmits the key acquisition request to the Authenticator. The key acquisition request message includes information such as the MN-ID, the pAR-ID, a length of the Kf and a derivation algorithm. The key acquisition request message can be protected with cryptography. The used protection mode can be the IP security (IPSec), the Transport Layer Security (TLS), and so on.

In step s503, the authentication function entity Authenticator transmits a key acquisition response to the pAR, the response message carrying the key Kf.

After receiving the key acquiring request from the pAR, the authentication function entity Authenticator determines the MSK shared with the MN according to the MN-ID, generates the Kf by using the same method as the MN in step s501, transmits the key acquisition response message to the pAR, and distributes the key Kf to the pAR. In addition, the key response message also needs cryptography protection.

In step s504, the pAR authenticates the authentication code in the FBU message, and transmits the FBack message to the MN after the authentication code passes authentication.

After receiving Kf handed out by Authenticator, the pAR authenticates the authentication code in the FBU message by using Kf. After the authentication code passes authentication, the FBack message is generated and transmitted to the MN.

By using the method provided in the embodiment of the present disclosure, the shared key MSK between the MN and the network side device is used to derive the fast-handover signaling protection key Kf to protect the fast-handover signaling, which solves the security problem of the fast-handover message during a mobile IPv6 fast handover, makes overhead become less during storing and calculating regarding the MN, and can be used to protect the downward fast-handover signaling of the SeND protocol that cannot be supported by the MN.

Except using the method for authenticating the FBU message provided in the second embodiment and the third embodiment to protect a mobile IPv6 fast handover, the mobile IPv6 fast handover can also be protected by establishing the key for protecting the mobile IPv6 fast handover in the route solicitation for proxy advertisement RtSolPr message and the proxy router advertisement PrRtAdv message conventional to the FBU message.

In the fourth embodiment of the present disclosure, taking the fact that the authentication function entity Authenticator outside the previous access router authenticates the access authentication of the mobile node as an example, the protection method for a mobile IPv6 fast handover by the RtSolPr/PrRtAdv message is described.

In the embodiment, a protection method for a mobile IPv6 fast handover is described below with reference to FIG. 6. The protection method includes the following steps.

In step s601, the MN transmits the RtSolPr message to the pAR. The RtSolPr message carries the MN identification, the authentication code generated by using the Kf which is derived from the master session key MSK, and the information required for authenticating the access authentication.

Specifically, when the MN transmits the RtSolPr message, the used key Kf is derived according to the MSK, and one of the selectable derivation methods is shown as follows:

Kf=KDF(MSK,Label|pAR_ID|MN_ID|nAR-ID|Nc|Key_length).

Unlike the above embodiment, in this embodiment one Casual Number (Nc) generated by the MN is used when Kf is generated.

The MN generates the authentication code of the RtSolPr message by using the Kf, and the RtSolPr message carries the algorithm for deriving the Kf, and the information such as the Nc, the pAR-ID, the nAR_ID and the Authenticator-ID. And the MN transmits the RtSolPr message to the previous access router.

In step s602, the pAR transmits a key acquisition request to the authentication function entity Authenticator.

When receiving the RtSolPr message from the MN, the pAR extracts the content included in the message and transmits the key acquisition request to the Authenticator corresponding to the Authenticator-ID. The key acquisition request message includes information such as the MN-ID, the pAR-ID, the Nc, the nAR_ID, a length of the Kf and a derivation algorithm, and can also carry one casual number Na generated by the pAR for avoiding the replay attack. The key acquisition request message can be protected with cryptography. The used protection mode can be the IP security (IPSec), the Transport Layer Security (TLS), and so on.

In step s603, the authentication function entity Authenticator transmits a key acquisition response to the pAR, the response message carrying the key Kf.

After receiving the key acquisition request form the pAR, the authentication function entity Authenticator determines the MSK shared with the MN according to the MN-ID, generates the Kf by using the same method as the MN in step s601, transmits the key acquisition response message to the pAR, and distributes the key Kf to the pAR. The message further includes the Na received in the previous step, for avoiding replay attack. In addition, the key response message also needs cryptography protection.

In step s604, the pAR authenticates the authentication code in the RtSolPr message, and transmits the PrRtAdv message to the MN after the authentication code passes authentication.

After the pAR receives the key response message of the authentication function entity Authenticator, the pAR first extracts out the Kf after authentication performed with the Na, and the pAR authenticates the authentication code in the RtSolPr message by using the Kf. When the authentication code passes authentication, the PrRtAdv message and its authentication code are generated and transmitted to the MN.

In step s605, the MN transmits FBU message to the pAR.

After the MN receives the PrRtAdv message transmitted by the pAR, the MN authenticates the authentication code carried in the message by using the Kf. When the authentication code passes authentication, the FBU message is generated, and the authentication code of the FBU message is generated by using the Kf. The FBU message carrying the newly generated authentication code is transmitted to the pAR. The pAR has saved the Kf used by the MN, and thus the subsequent fast-handover flow can be performed continuously according to the method in the conventional art, with the difference that the subsequent signaling interaction always uses the Kf for protection.

Furthermore, to improve security, in each embodiment described above, a private identifier MN-PID can be generated for the MN according to the shared key between the Authenticator and the MN. The MN-ID in all messages is replaced by the private identifier, and it is identified in the message that the private identifier is used.

MN-PID=PRF(Kp,MN-ID|Authenticator-ID),

where the Kp is the shared key between the MN and the Authenticator and the Kp can be the Kf, the MSK or its derived key, and the Pseudo Random Function (PRF) is the algorithm used to acquire the MN-PID. In the step of generating the Kf by the Authenticator, the original MN-ID can be acquired by using the MN-PID.

Furthermore, to restrain the MN from selecting the address of other nodes as the nCoA to attack, in each embodiment described above, an interface identification nCoA_IID of the nCoA can be generated by using the following way to replace the nCoA in all messages.

nCoA_IID=PRF(Knr,nCoA_prefix|pCoA|nAR|pAR),

where the Knr is the shared key between the MN and the pAR, and the nCoA_IID is generated by concatenating the prefix nCoA_prefix of the new access link of the nCoA in the PrRtAdv and the interface identification together.

After the nCoA_IID is generated, the pAR needs to notify the MN in the PrRtAdv message that it needs to use the nCoA_IID.

By using the method provided in the above embodiment of the present disclosure, the shared key between the mobile node and the network side device is used to derive the fast-handover signaling protection key to protect the fast-handover signaling, which solves the security problem of the fast-handover message during a mobile IPv6 fast handover, makes overhead become less during storing and calculating regarding the mobile node, and can be used to protect the downward fast-handover signaling of the SeND protocol that cannot be supported by the mobile node.

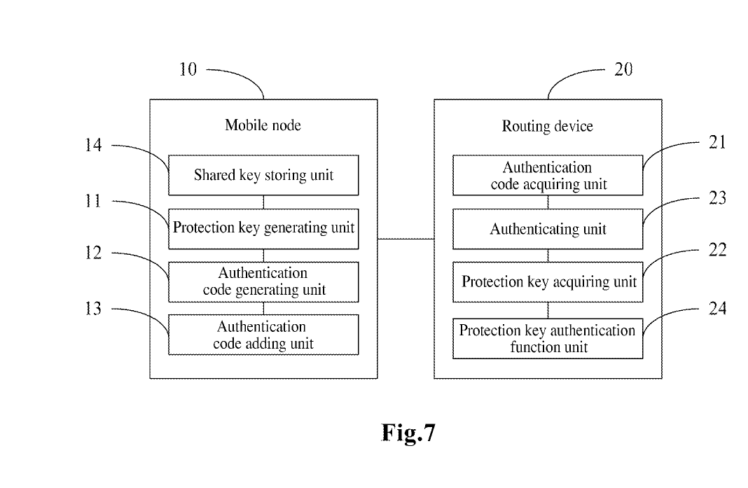

In the fifth embodiment of the present disclosure, a protection system for a mobile IPv6 fast handover is further provided, with the structure as shown in FIG. 7. The protection system includes a mobile node 10 and a routing device 20, where a fast-handover signaling protection key for protecting the fast-handover signaling is derived by using the shared key between the mobile node and the network side device.

Specifically, the mobile node 10 further includes:

a protection key generating unit 11, configured to generate the fast-handover signaling protection key by using the key shared with the network side device. The shared key can be the MSK which is generated during an access authentication of the mobile node and is shared between the network side device and the mobile node;

an authentication code generating unit 12, configured to generate an authentication code according to the protection key generated by the protection key generating unit 11. The step of generating the protection key can also involve other parameters including one or a plurality of the following parameters: a mobile node device identification, a previous router identification, a rear router identification, a preset character string, a previous care of address, a new care of address, a length of the protection key and a random number; and

an authentication code adding unit 13, configured to add the authentication code generated by the authentication code generating unit 12 to the fast-handover signaling and transmit the fast-handover signaling to a router. The fast-handover signaling can be the router solicitation for proxy advertisement (RtSolPr) message or the fast binding update FBU message.

In addition, the mobile node 10 further includes:

a shared key storing unit 14, configured to store the key shared with the network side device and provide the shared key to the protection key generating unit 11 for generating the protection key. The shared key can be the master session key MSK which is generated during an access authentication of the mobile node and is shared between the network side device and the mobile node.

Specifically, the routing device 20 further includes:

an authentication code acquiring unit 21, configured to acquire an authentication code carried in a fast-handover signaling from the mobile node 10;

a protection key acquiring unit 22, configured to acquire, from a local device or a network side device, a protection key which is used by the mobile node 10 to generate the authentication code, wherein the protection key is generated by the mobile node 10 using a key shared with the network side device; and

an authenticating unit 23, configured to authenticate, according to the protection key acquired by the protection key acquiring unit 22, the authentication code acquired by the authentication code acquiring unit 21, and configured to transmit a response to the mobile node 10 when the authentication code passes authentication.

In addition, the routing device 20 further includes:

a protection key authentication function unit 24, configured to acquire the protection key according to the key shared with the mobile node 10 and according to a parameter required for generating the protection key, and provide the protection key to the protection key acquiring unit 22. In a specific network environment, the protection key authentication function unit 24 can also be taken as a separate function entity located outside the routing device 20.

By the system and the device provided in the above embodiments of the present disclosure, the shared key between the mobile node and the network side device is used to derive the fast-handover signaling protection key to protect the fast-handover signaling, which solves the security problem of the fast-handover message during a mobile IPv6 fast handover, makes overhead become less during storing and calculating regarding the mobile node, and can be used to protect the downward fast-handover signaling of the SeND protocol that cannot be supported by the mobile node.

With the description of the above embodiments, persons skilled in the art can clearly appreciate that the present disclosure can be realized by means of a hardware or by means of a software plus a necessary common hardware platform. Based on the understanding, the technical solutions of the present disclosure substantially can be embodied in the form of a software product. The software product is stored in a nonvolatile storage medium (which can be CD-ROM, USB flash drive, mobile hard disc drive, and so on), including a plurality of instructions for making computer equipment (which can be a personal computer, a server or network equipment, and so on) to execute the methods stated in the embodiments of the present disclosure.

To sum up, the above contents are only preferred embodiments of the present disclosure, and are not intended to limit the protection scope of the present disclosure. Any modification, equivalent replacement and improvements in the spirit and the principle of the present disclosure shall be covered in the protection scope of the present disclosure.

What is claimed is:

1. A protection method for a mobile Internet Protocol version 6 (IPv6) fast handover, comprising:
generating a fast-handover signaling protection key by using a key which is shared with a network side device;
generating an authentication code according to the protection key; and
adding the authentication code to a fast-handover signaling and transmitting the fast-handover signaling to a router.

2. The protection method for a mobile IPv6 fast handover according to claim 1, wherein the step of generating the fast-handover signaling protection key by using the key shared with the network side device comprises:
generating the fast-handover signaling protection key by using the key shared with the network side device and by using one or more of the following parameters: a present node device identification, a previous router identification, a rear router identification, a preset character string, a previous care of address, a new care of address, a length of the protection key, and a random number.

3. The protection method for a mobile IPv6 fast handover according to claim 1, wherein the key shared with the network side device is a master session key Master Session Key (MSK) generated during an access authentication.

4. The protection method for a mobile IPv6 fast handover according to claim 2, wherein the key shared with the network side device is a master session key Master Session Key (MSK) generated during an access authentication.

5. The protection method for a mobile IPv6 fast handover according to claim 2, wherein the present node device identification is one of a true identification of the present node device and a private identification previously generated by the network side device for the present node device.

6. The protection method for a mobile IPv6 fast handover according to claim 1, wherein the fast-handover signaling is one of a router solicitation for proxy advertisement RtSolPr message and a fast binding update Fast Binding Update (FBU) message.

7. A protection method for a mobile Internet Protocol version 6 (IPv6) fast handover, comprising:
receiving the fast-handover signaling which carries an authentication code and is transmitted by a mobile node;
acquiring a protection key which is used by the mobile node to generate the authentication code, wherein the protection key is generated by the mobile node using a key shared with a network side device; and
authenticating the authentication code of the fast-handover signaling according to the protection key, and transmitting a response to the mobile node when the authentication code passes authentication.

8. The protection method for a mobile IPv6 fast handover according to claim 7, wherein the step of acquiring the protection key which is used by the mobile node to generate the authentication code comprises:
acquiring the protection key according to the key shared with the mobile node and according to a parameter which is carried in the fast-handover signaling and is required for generating the protection key.

9. The protection method for a mobile IPv6 fast handover according to claim 7, wherein the step of acquiring the protection key which is used by the mobile node to generate the authentication code comprises:
sending a key acquisition request message to a corresponding authentication function entity on the network side device, wherein the key acquisition request message carries a parameter required for generating the protection key; and
receiving the protection key sent by the authentication function entity which is generated according to the key shared with the mobile node and according to the parameter.

10. The protection method for a mobile IPv6 fast handover according to claim 7, wherein the key shared with the mobile node is a master session key Master Session Key (MSK) which is generated during an access authentication of the mobile node.

11. The protection method for a mobile IPv6 fast handover according to claim 8, wherein the key shared with the mobile node is a master session key Master Session Key (MSK) which is generated during an access authentication of the mobile node.

12. The protection method for a mobile IPv6 fast handover according to claim 8, wherein the parameter required for generating the protection key comprises one or a plurality of the following parameters: a present node device identification, a previous router identification, a rear router identification, a preset character string, a previous care of address, a new care of address, a length of the protection key, and a random number.

13. The protection method for a mobile IPv6 fast handover according to claim 9, wherein the parameter required for generating the protection key comprises one or a plurality of the following parameters: a present node device identification, a previous router identification, a rear router identification, a preset character string, a previous care of address, a new care of address, a length of the protection key, and a random number.

14. A mobile node, comprising:
a protection key generating unit, configured to generate a fast-handover signaling protection key by using a key which is shared with a network side device;
an authentication code generating unit, configured to generate an authentication code according to the protection key generated by the protection key generating unit; and
an authentication code adding unit, configured to add the authentication code generated by the authentication code generating unit to a fast-handover signaling and transmit the fast-handover signaling to a router.

15. The mobile node according to claim 14, further comprising:
a shared key storing unit, configured to store the key shared with the network side device and provide the key to the protection key generating unit for generating the protection key.

16. A routing device, comprising;
an authentication code acquiring unit, configured to acquire an authentication code carried in a fast-handover signaling from a mobile node;
a protection key acquiring unit, configured to acquire, from a local device or a network side device, a protection key which is used by the mobile node to generate the authentication code, wherein the protection key is generated by the mobile node using a key shared with a network side device; and
an authenticating unit, configured to authenticate, according to the protection key acquired by the protection key acquiring unit, the authentication code acquired by the authentication code acquiring unit, and configured to transmit a response to the mobile node when the authentication code passes authentication.

17. The routing device according to claim 16, further comprising:
a protection key authentication function unit, configured to acquire the protection key according to the key shared with the mobile node and according to a parameter required for generating the protection key, and provide the protection key to the protection key acquiring unit.

18. A protection system for a mobile Internet Protocol version 6 (IPv6) fast handover, comprising the mobile node according to claim 14 and the routing device according to claim 16.

19. A protection system for a mobile Internet Protocol version 6 (IPv6) fast handover, comprising the mobile node according to claim 14 and the routing device according to claim 17.
